(19) United States
(12) Patent Application Publication
(10) Pub. No.: US 2026/0028008 A1
(43) Pub. Date: Jan. 29, 2026

(54) HYDRAULIC SUPPLY DEVICE

(71) Applicant: HL MANDO CORPORATION, Gyeonggi-do (KR)

(72) Inventor: Kwangseok HONG, Gyeonggi-do (KR)

(21) Appl. No.: 18/988,882

(22) Filed: Dec. 19, 2024

(30) Foreign Application Priority Data
Jul. 29, 2024 (KR) 10-2024-0100251

(51) Int. Cl. B60T 13/74; B60T 13/16; H02K 7/00; H02K 11/215

(52) U.S. Cl. CPC B60T 13/745; B60T 13/168; H02K 7/003; H02K 11/215

(57) ABSTRACT

Provided is a hydraulic supply device. A hydraulic supply device according to one aspect of the present invention includes a motor which is coupled to a modulator block, in which a path and a valve for adjusting a hydraulic braking pressure are provided, and which includes a stator and a rotor, a rotary shaft which is coupled to the rotor and performs a rotary motion along with the rotor, and a magnet assembly which is coupled to the rotary shaft and includes a magnet disposed to face a motor position sensor for measuring an amount of rotation of the rotary shaft, wherein the magnet assembly may include a shaft, which is coaxially and linearly connected to and rotated along with the rotary shaft and of which one end portion supports the magnet, and a tolerance ring which is mounted on an outer circumferential surface of the shaft and inserted into an installation groove formed in the rotary shaft to fasten the shaft to the rotary shaft, wherein a rotation restriction protrusion for restricting rotation of the tolerance ring around the shaft may be formed on the tolerance ring.

### CROSS-REFERENCE TO RELATED APPLICATION

This application claims priority to and the benefit of Korean Patent Application No. 10-2024-0100251, filed on JULY 29, 2024, the disclosure of which is incorporated herein by reference in its entirety.

### BACKGROUND

### Technical Field

The present invention relates to a hydraulic supply device, and more specifically, to a hydraulic supply device which is provided in an electronic brake system and generates a hydraulic pressure.

### Discussion of Related Art

In general, brake systems for braking are requisitely mounted in vehicles. Recently, various types of electronic brake systems have been proposed to obtain greater and more stable braking forces. As an example, intelligent integrated dynamic brake (IDB) systems have been proposed.

An integrated electronic brake system includes a hydraulic supply device which outputs an electrical signal for a motion of a brake pedal using a pedal displacement sensor to operate a motor and converts a rotational force of the motor to a linear motion to generate hydraulic braking pressure, a modulator block in which a plurality of valves are installed such that a braking operation is controlled by hydraulic pressure generated by a force generated by a hydraulic fluid supply device, and an electronic control unit which controls the motor and the valves.

Meanwhile, the integrated electronic brake system may further include a motor position sensor (MPS) for measuring an operation state of the motor. The MPS measures a direction and amount of rotation and the like of the motor by detecting a change in magnetic field caused by a magnet rotating based on the rotation of the motor.

In this case, it is very important to maintain a gap between the magnet and the MPS to transfer accurate rotation information of the motor to the electronic control unit.

Therefore, a separate mechanism for maintaining a gap between a magnet and an MPS and connecting the magnet to a rotor of a motor is required.

### SUMMARY

The present invention is directed to providing a hydraulic supply device capable of maintaining a gap between a magnet and a motor position sensor and formed such that a rotary shaft rotated by a motor is connected to the magnet.

In addition, the present invention is directed to providing a hydraulic supply device capable of accurately and stably measuring, by a motor position sensor, rotation information of a motor.

The objects of the present disclosure are not limited to the above-described objects, and other objects that are not mentioned will be able to be clearly understood by those skilled in the art to which the present disclosure pertains from the following description.

In accordance with one aspect of the present invention, there is provided a hydraulic supply device including a motor which is coupled to a modulator block, in which a path and a valve for adjusting a hydraulic braking pressure are provided, and which includes a stator and a rotor, a rotary shaft which is coupled to the rotor and performs a rotary motion along with the rotor, and a magnet assembly which is coupled to the rotary shaft and includes a magnet disposed to face a motor position sensor for measuring an amount of rotation of the rotary shaft, wherein the magnet assembly includes a shaft, which is coaxially and linearly connected to and rotated along with the rotary shaft and of which one end portion supports the magnet, and a tolerance ring which is mounted on an outer circumferential surface of the shaft and inserted into an installation groove formed in the rotary shaft to fasten the shaft to the rotary shaft, wherein a rotation restriction protrusion for restricting rotation of the tolerance ring around the shaft is formed on the tolerance ring.

In this case, the tolerance ring may include a tolerance ring body which extends in a longitudinal direction of the shaft, is mounted on the outer circumferential surface of the shaft, and has a ring shape and at least one contact protrusion which is formed on an outer circumferential surface of the tolerance ring body and comes into contact with an inner circumferential surface of the installation groove.

In this case, the rotation restriction protrusion may be supported by the shaft to restrict the rotation of the tolerance ring body around the shaft.

In this case, the rotation restriction protrusion may be formed to extend in a longitudinal direction of the tolerance ring body from on at least one of one side and the other side of the tolerance ring body in the longitudinal direction.

In this case, a ring insertion groove, which extends in the longitudinal direction of the shaft and in which the tolerance ring body is inserted and mounted, may be formed in the outer circumferential surface of the shaft.

In this case, a protrusion support surface, which is adjacent to the ring insertion groove in a longitudinal direction of the ring insertion groove and is in contact with and supports the rotation restriction protrusion, may be formed on the outer circumferential surface of the shaft.

In this case, the protrusion support surface may be formed as a curved surface, and the protrusion support surface may be formed to have a greater radius of curvature than a remaining region other than a region in which the protrusion support surface is formed in a circumferential direction of the shaft.

Meanwhile, the protrusion support surface may be formed as a flat surface.

Meanwhile, a protrusion insertion groove, which is adjacent to the ring insertion groove in a longitudinal direction of the ring insertion groove and into which the rotation restriction protrusion is inserted, may be formed in the outer circumferential surface of the shaft.

Meanwhile, a cut portion extending in a longitudinal direction of the tolerance ring body may be formed in the tolerance ring body.

Meanwhile, the magnet assembly may further include a holder fixed to one end of the shaft and provided with an accommodation space, and the magnet may be mounted in the accommodation space.

Meanwhile, the shaft may be provided with a high-elastic part having greater elasticity than a remaining portion of the shaft.

In this case, the high-elastic part may have a relatively small cross-sectional area compared to the remaining portion of the shaft.

Meanwhile, the high-elastic part may be located in a central region of the shaft.

Meanwhile, the hydraulic supply device may further include a ball nut of which one side is coupled to a piston and which is coaxially connected to the rotary shaft in a ball screw manner and converts a rotary motion of the rotary shaft to a linear motion.

Meanwhile, the hydraulic supply device may further include a bearing which rotatably supports the shaft, and the bearing may be supported by a pump housing coupled to the modulator block to surround a piston and the shaft.

Meanwhile, the hydraulic supply device may further include a pump housing which is fastened to the modulator block from a side opposite to the motor and forms a cylinder such that a piston passing through the modulator block performs a reciprocating linear motion.

In this case, a guide part having a cylindrical shape of which one side is open may be provided in the pump housing such that the cylinder is divided into a first space portion accommodating the shaft and a second space portion accommodating the piston.

In accordance with another aspect of the present invention, there is provided a hydraulic supply device coupled to a modulator block in which a path and a valve for adjusting a hydraulic braking pressure is provided, the hydraulic supply device including a motor including a stator and a rotor, a rotary shaft which is coupled to the rotor and performs a rotary motion along with the rotor, and a magnet assembly coupled to the rotary shaft, wherein the magnet assembly includes a shaft coaxially and linearly connected to and rotated along with the rotary shaft, a magnet which is supported by one end portion of the shaft and disposed to face a motor position sensor for measuring an amount of rotation of the rotary shaft, and a tolerance ring mounted on an outer circumferential surface of the shaft and inserted into an installation groove formed in the rotary shaft to fasten the shaft to the rotary shaft, and the tolerance ring includes a tolerance ring body extending in a longitudinal direction of the shaft, mounted on the outer circumferential surface of the shaft, and having a ring shape and a rotation restriction protrusion formed on the tolerance ring body to restrict rotation of the tolerance ring body around the shaft.

In this case, the rotation restriction protrusion may be formed to extend in a longitudinal direction of the tolerance ring body on at least one of one side and the other side of the tolerance ring body in the longitudinal direction.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a cross-sectional view illustrating a hydraulic supply device according to one embodiment of the present invention;

FIG. 2 is a partially enlarged view illustrating the hydraulic supply device according to one embodiment of the present invention;

FIG. 3 is a perspective view illustrating a magnet assembly according to one embodiment of the present invention;

FIG. 4 is an exploded perspective view illustrating the magnet assembly according to one embodiment of the present invention;

FIG. 5 is a partial perspective view illustrating a shaft of the magnet assembly according to one embodiment of the present invention;

FIG. 6 is a perspective view illustrating a tolerance ring of the magnet assembly according to one embodiment of the present invention;

FIG. 7 is a view illustrating one modified example of a protrusion support portion supporting a rotation restriction protrusion according to one embodiment of the present invention; and

FIG. 8 is a perspective view illustrating a magnet assembly according to another embodiment of the present invention.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used In the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

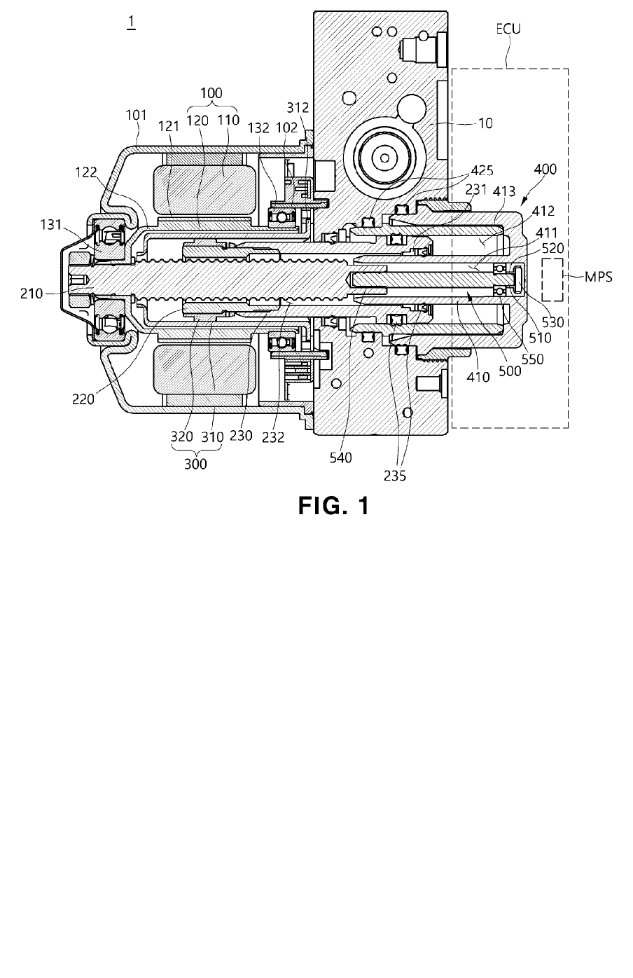

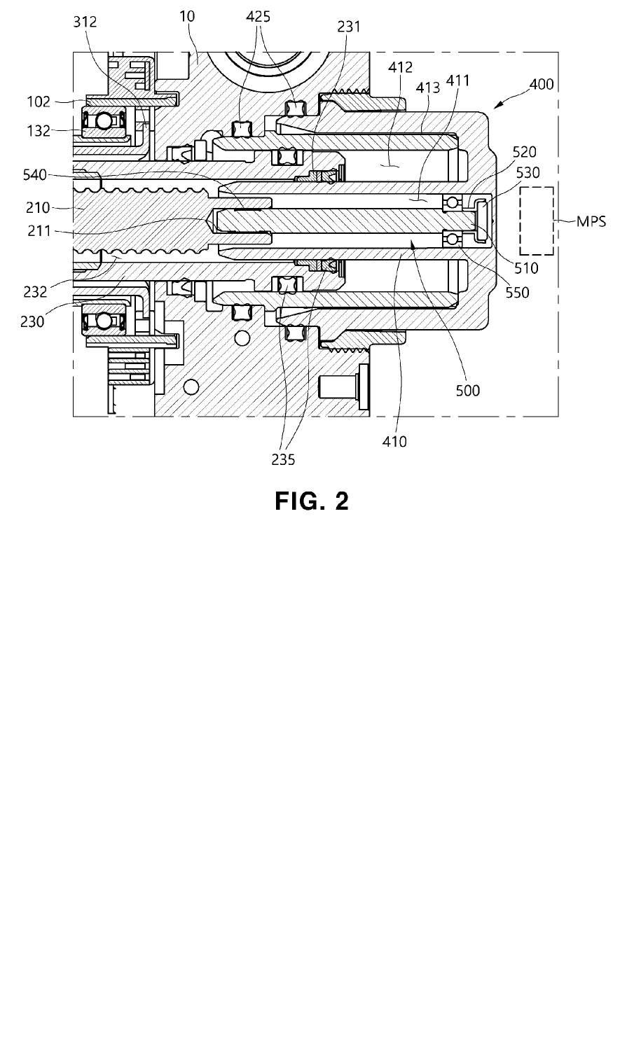

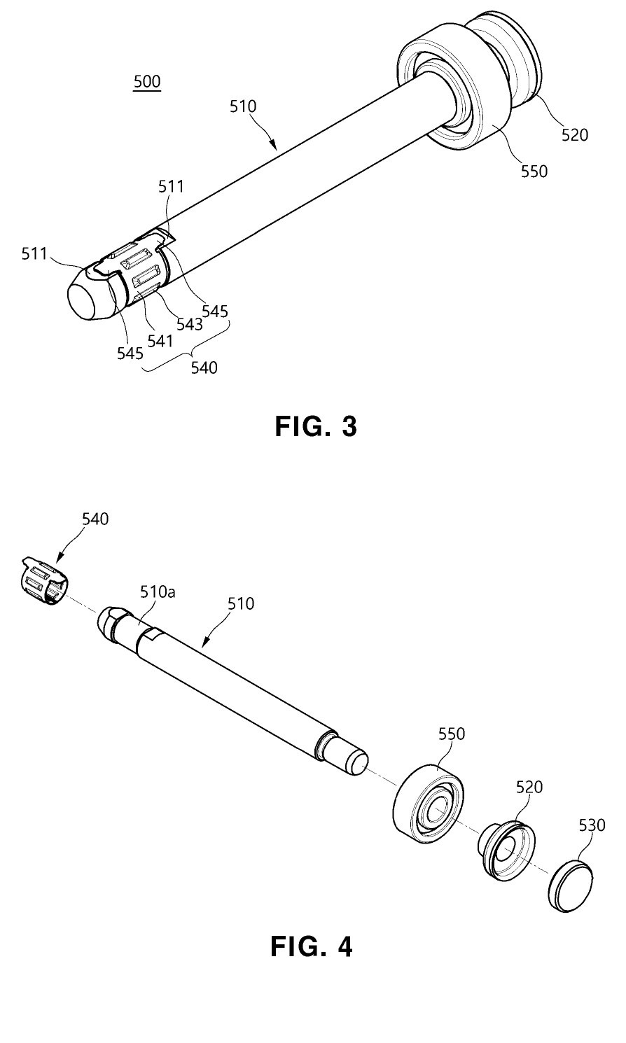

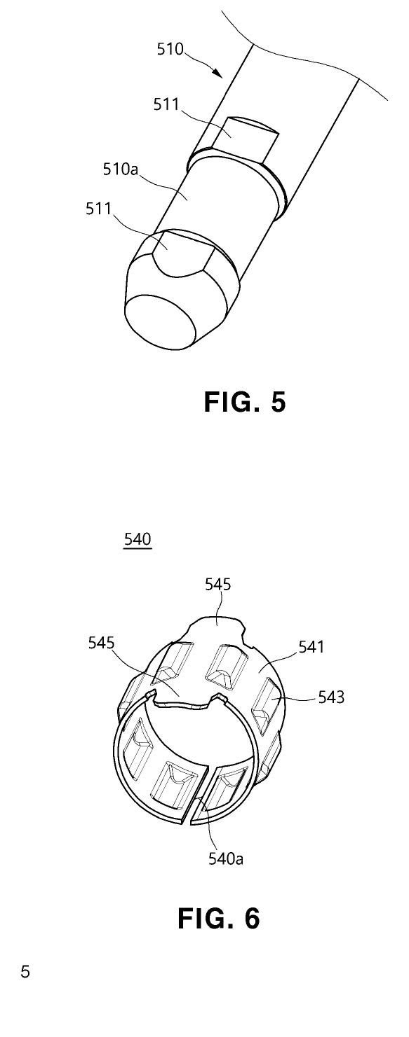

FIG. 1 is a cross-sectional view illustrating a hydraulic supply device according to one embodiment of the present invention, FIG. 2 is a partially enlarged view illustrating the hydraulic supply device according to one embodiment of the present invention, and FIG. 3 is a perspective view illustrating a magnet assembly according to one embodiment of the present invention. FIG. 4 is an exploded perspective view illustrating the magnet assembly according to one embodiment of the present invention, FIG. 5 is a partial perspective view illustrating a shaft of the magnet assembly according to one embodiment of the present invention, and FIG. 6 is a perspective view illustrating a tolerance ring of the magnet assembly according to one embodiment of the present invention.

Referring to FIGS. 1 to 6, a hydraulic supply device 1 according to one embodiment of the present invention includes a motor 100 coupled to a modulator block 10, a rotary shaft 210 coupled to a rotor 120 of the motor 100, a ball nut 220 of which one side is coupled to a piston 230 and which is connected to the rotary shaft 210 in a ball screw manner, a rotation prevention part 300 which prevents the rotary shaft 210 and the ball nut 220 from rotating with each other, and a magnet assembly 500 coupled to the rotary shaft 210.

The modulator block 10 is connected to the hydraulic supply device 1 and a master cylinder (not shown). A path and a valve for adjusting a hydraulic braking pressure are provided in the modulator block 10.

An electronic control unit (ECU) is installed on the modulator block 10, and a hydraulic braking pressure is transferred to a wheel cylinder provided on each vehicle wheel by the ECU by controlling the valve and the motor 100 of the hydraulic supply device 1.

In this case, a motor position sensor (MPS) which detects a change in magnetic field due to a magnet 530 of the magnet assembly 500 may be provided in the ECU. Since the modulator block 10 is a widely-known technology related to an electronic brake system, a detailed description thereof will be omitted.

A motor housing 101 and a pump housing 400 are fastened to both sides of the modulator block 10.

In FIG. 1, the motor housing 101 is fastened to a left side of the modulator block 10 and formed to surround the motor 100 which will be described below. In addition, a motor cover 102 is interposed between the motor 100 disposed in the motor housing 101 and the modulator block 10. In this case, the motor housing 101 is fastened to the modulator block 10 in a state of being coupled to the motor cover 102.

The pump housing 400 is fastened to the modulator block 10 from a side opposite to the motor housing 101 based on the modulator block 10 and forms a cylinder in which the piston 230 performs a reciprocating motion.

In this case, a second space portion 412 which is a pump chamber into which an operating fluid is introduced is formed in a space between the cylinder formed by the pump housing 400 and the piston 230, and pump sealing members 425 for preventing the leakage of the operating fluid are provided between an outer surface of the pump housing 400 and the modulator block 10.

According to one embodiment of the present invention, a guide part 410 having a cylindrical shape of which one side is open to accommodate a shaft 510 of the magnet assembly 500, which will be described below, may be provided in the pump housing 400.

The cylinder formed by the pump housing 400 may be divided by the guide part 410 into a first space portion 411 which is an inner space of the guide part 410 and a second space portion 412 accommodating the piston 230.

In addition, a path 413 connected to the second space portion 412 may be formed in the pump housing 400. That is, the operating fluid accommodated in the second space portion 412, which is the pump chamber, enters or exits an inner path of the modulator block 10 through the path 413 based on the operation of the piston 230.

The motor 100 receives power and generates a rotational force. The motor 100 may be provided as a hollow motor including a stator 110 and the rotor 120 which are installed in the motor housing 101.

The rotor 120 has a hollow cylindrical shape, and magnetic bodies 121 are installed at predetermined intervals along an outer circumferential surface of the rotor 120. The stator 110 is formed to be spaced a predetermined distance from the rotor 120 and to surround the rotor 120. A coil (not shown) is wound around the stator 110. When power is applied to the coil (not shown), a repulsive force and an attractive force act between the magnetic bodies 121 and the coil so that the rotor 120 rotates.

Since the structures and operations of the rotor 120 and the stator 110 of the motor 100 are widely-known technologies, detailed descriptions thereof will be omitted.

Meanwhile, since the hydraulic supply device 1 of the present invention is applied to and used in the electronic brake system, the motor 100 may be operated according to an electric signal of a pedal displacement sensor (not shown) for detecting a displacement according to a depression force of a brake pedal. In this case, the motor 100 normally or reversely rotates to generate a rotational force to generate a braking force required by a driver.

The rotary shaft 210 may have a predetermined length and may be disposed at a center of the motor 100 and rotated with the rotor 120. For example, the rotary shaft 210 may rotate with a rotating part 122 of the rotor 120 as illustrated in FIG. 1.

The rotating part 122 may be formed to be hollow in a longitudinal direction such that the rotary shaft 210 is located in the rotating part 122. In this case, an inner diameter of a rear side (left side in FIG. 1) of the rotating part 122 is provided to be decreased and rotatably coupled to the rotary shaft 210. A front side and the rear side of the rotating part 122 are supported by a front bearing 132 and a rear bearing 131, respectively, such that the rotating part 122 may stably rotate with the rotor 120.

The rear bearing 131 is interposed between the motor housing 101 and the rotating part 122 and supports the rear side of the rotating part 122, and the front bearing 132 is interposed between the motor cover 102 and the rotating part 122 and supports the front side of the rotating part 122.

In this case, since the front bearing 132 and the rear bearing 131 may stably support front and rear sides of the rotating part 122, the rotor 120 may rotate with the rotating part 122 without shaking.

The rotary shaft 210 is formed as a screw shaft which is press-fitted to the rotating part 122 and rotates with the rotating part 122. In this case, as a thread groove is formed in an outer circumferential surface of the rotary shaft 210, and a rear side of the rotary shaft 210 is fixedly press-fitted to the rear side of the rotating part 122, the rotary shaft 210 rotates with the rotating part 122.

The ball nut 220 is provided to be coupled to the rotary shaft 210 in a ball screw manner to convert a rotary motion to a reciprocating linear motion.

Although not illustrated in the drawings, a plurality of balls may fill a space between the rotary shaft 210 and the ball nut 220 to decrease energy due to friction therebetween. In this case, the rotary shaft 210 and the ball nut 220 may be formed as a power conversion unit of a ball-screw type.

The rotation prevention part 300 is provided to allow the ball nut 220 to linearly move according to the rotation of the rotary shaft 210.

The rotation prevention part 300 may include a sleeve 310 provided to be fixed to the motor housing 101 or the modulator block 10 and surround the ball nut 220 and a ring member 320 coupled to the sleeve 310 to prevent rotation.

The sleeve 310 is formed to be hollow in a longitudinal direction such that the ball nut 220 is located in the sleeve 310, and at least one slot (not shown) is formed in an inner surface of the sleeve 310 in the longitudinal direction. A plurality of slots (not shown) may be provided in the inner surface of the sleeve 310 to be spaced apart from each other at equal intervals in parallel in a circumferential direction.

In addition, the sleeve 310 may be disposed to be spaced a predetermined distance from the rotating part 122 such that the sleeve 310 is not interfered with the rotor 120 and may include a flange 312 of which one side is fixed to the motor housing 101. According to the drawings, the flange 312 may be fixed to the motor cover 102 of the motor housing 101.

The ring member 320 is press-fitted and coupled to the ball nut 220, and at least one restriction protrusion (not shown) is formed on an outer circumferential surface of the ring member 320. The ring member 320 is provided at a location corresponding to the slot formed in the sleeve 310 of the restriction protrusion. Accordingly, the restriction protrusion prevents the rotation of the ball nut 220 and moves along the slot according to the movement of the ball nut 220.

Meanwhile, the piston 230 is coupled to one side of the ball nut 220, and the ball nut 220 performs a reciprocating linear motion with the piston 230. The piston 230 has a hollow cylindrical shape, one end of the piston 230 is coupled to the ball nut 220, and the other end thereof is inserted into the cylinder of the pump housing 400.

The rotary shaft 210 and the guide part 410 of the pump housing 400 may be accommodated in a hollow portion 232 of the piston 230. In this case, a guide bush 231 may be provided between an inner surface of the piston 230 and an outer surface of the guide part 410.

That is, as the guide bush 231 is guided along the outer surface of the guide part 410 while the piston 230 performs a linear motion, the piston 230 may stably perform a linear motion.

Sealing members 235 are provided between an outer surface of the piston 230 and the pump housing 400 and between the inner surface of the piston 230 and the guide part 410 to prevent the leakage of oil while the piston 230 operates.

The magnet assembly 500 according to one embodiment of the present invention is coupled to the rotary shaft 210. The magnet assembly 500 is an assembly including the magnet 530 disposed to face the MPS for measuring an amount of the rotation of the rotary shaft 210.

In one embodiment of the present invention, the magnet assembly 500 may include the shaft 510 coaxially and linearly connected to the rotary shaft 210, a holder 520 fixed to an end of the shaft 510, the magnet 530 mounted on the holder 520, and a tolerance ring 540 mounted on an outer circumferential surface of the shaft 510.

The shaft 510 may have a predetermined length, and one end of the shaft 510 may be press-fitted and coupled to an installation groove 211 formed in an end of the rotary shaft 210.

In this case, the tolerance ring 540 mounted on the outer circumferential surface of the shaft 510 may be inserted into and fastened to the installation groove 211 along with the shaft 510. The shaft 510 is restricted along with the rotary shaft 210 in a rotating direction by the tolerance ring 540 and performs a rotary motion along with the rotary shaft 210.

One end of the holder 520 is fixed to the end of the shaft 510, and an accommodation space in which the magnet 530 is accommodated is provided in the other end of the holder 520. That is, the holder 520 and the magnet 530 are provided at a side opposite to a side at which the shaft 510 is coupled to the rotary shaft 210. Accordingly, the shaft 510 rotates with the holder 520 and the magnet 530 while rotating along with the rotary shaft 210.

Meanwhile, the magnet assembly 500 may further include a bearing 550 rotatably supporting the shaft 510. The bearing 550 is supported by an inner side of the guide part 410 and supports the shaft 510 in a diameter direction of the shaft 510 to allow the shaft 510 and the magnet 530 to stably rotate.

The magnet assembly 500 may be formed such that the magnet 530 supported by one end portion of the shaft 510 is disposed to face the MPS provided in the ECU. Accordingly, the MPS measures a direction and amount of the rotation of the rotary shaft 210 by detecting a change in magnetic field caused by the magnet 530.

In this case, the ECU may check a motion of the piston 230 and control an operation of the motor 100 on the basis of information detected by the MPS.

In one embodiment of the present invention, the tolerance ring 540 may include a tolerance ring body 541 mounted on the outer circumferential surface of the shaft 510 and contact protrusions 543 formed on an outer circumferential surface of the tolerance ring body 541.

The tolerance ring body 541 extends in a longitudinal direction of the shaft 510 and is mounted on the outer circumferential surface of the shaft 510. The tolerance ring body 541 has a ring shape. The tolerance ring body 541 having the ring shape may surround and be in contact with the outer circumferential surface of the shaft 510.

A cut portion 540a extending in an extension direction of the shaft 510 may be formed in the tolerance ring body 541. When the cut portion 540a is opened, the tolerance ring body 541 may be elastically deformed, an inner diameter of the tolerance ring body 541 may increase, and the shaft 510 may be easily inserted into the tolerance ring body 541 due to the increased inner diameter.

The tolerance ring body 541 may be in close contact with the outer circumferential surface of the shaft 510. In this case, a fastening force between the tolerance ring body 541 and the shaft 510 may be changed according to a contact force between the tolerance ring body 541 and the shaft 510.

The contact protrusions 543 are formed on the outer circumferential surface of the tolerance ring body 541. At least one contact protrusion 543 may be formed on the outer circumferential surface of the tolerance ring body 541. The contact protrusion 543 is in contact with an inner circumferential surface of the installation groove 211 formed in the rotary shaft 210 and fastens the shaft 510 to the rotary shaft 210.

In this case, a fastening force between the shaft 510 and the rotary shaft 210 may be changed according to a degree of contact between the contact protrusion 543 and the inner circumferential surface of the installation groove 211.

A ring insertion groove 510a which extends in a circumferential direction of the shaft 510 and into which the tolerance ring body 541 is inserted may be formed in the shaft 510. The ring insertion groove 510a may be formed to correspond to the tolerance ring body 541 and extend in the longitudinal direction of the shaft 510.

The movement of the tolerance ring body 541 inserted into the ring insertion groove 510a may be restricted in the longitudinal direction of the shaft 510. Even when an external force is applied to the tolerance ring 540 inserted into the ring insertion groove 510a in the longitudinal direction of the shaft 510, the tolerance ring 540 is caught by an inner sidewall of the ring insertion groove 510a so that the movement of the tolerance ring 540 is restricted.

According to one embodiment of the present invention, the tolerance ring 540 may further includes rotation restriction protrusions 545 for restricting the rotation of the tolerance ring body 541 around the shaft 510. The rotation restriction protrusions 545 are formed on the tolerance ring body 541 and supported by the shaft 510 such that the rotation of the tolerance ring body 541 around the shaft 510 is restricted.

When the fastening force between the tolerance ring body 541 and the shaft 510 decreases and the tolerance ring body 541 and the shaft 510 are relatively rotated, it may be difficult to measure an amount of the rotation of the shaft 510 or an amount of the rotation of the motor 100 connected to the shaft 510.

In order to solve such a problem, according to one embodiment of the present invention, the rotation restriction protrusions 545 for restricting the rotation of the tolerance ring 540 around the shaft 510 are formed on the tolerance ring 540.

In one embodiment of the present invention, the rotation restriction protrusions 545 may be formed on both sides of the tolerance ring body 541, respectively, in the longitudinal direction of the tolerance ring body 541 as illustrated in FIG. 6. However, although not illustrated in the drawings, the rotation restriction protrusions may be formed on any one of one side and the other side of the tolerance ring body in the longitudinal direction.

In one embodiment of the present invention, the rotation restriction protrusions 545 located on both sides of the tolerance ring body 541 in the longitudinal direction may be collinearly disposed parallel to the longitudinal direction of the shaft 510 as illustrated in FIG. 4.

Alternatively, although not illustrated in the drawings, the rotation restriction protrusions located at both sides of the tolerance ring body in the longitudinal direction may be disposed on different lines parallel to the longitudinal direction of the shaft.

In one embodiment of the present invention, one rotation restriction protrusion 545 is formed on each of both sides of the tolerance ring body 541 in the longitudinal direction thereof.

Alternatively, although not illustrated in the drawings, a plurality of rotation restriction protrusions may be formed on each of both sides of the tolerance ring body in the longitudinal direction. In this case, the plurality of rotation restriction protrusions formed on the same side of the tolerance ring body in the longitudinal direction may be disposed to be spaced apart from each other in a circumferential direction of the tolerance ring body.

In one embodiment of the present invention, protrusion support portions which support the rotation restriction protrusions 545 for restricting the rotation of the tolerance ring body 541 around the shaft 510 may be formed on the shaft 510.

As an example, the protrusion support portions may be protrusion support surfaces 511 formed on the outer circumferential surface of the shaft 510 adjacent to the ring insertion groove 510a in the longitudinal direction as illustrated in FIGS. 5 and 6. In this case, the rotation restriction protrusions 545 extending on the tolerance ring body 541 are in contact with and supported by the protrusion support surfaces 511.

The protrusion support surfaces 511 may be formed in some regions on the shaft 510 in the circumferential direction.

In this case, the protrusion support surface 511 may be a curved surface. In this case, the protrusion support surface 511 may have a radius of curvature which is greater than that of a remaining region other than a region in which the protrusion support surface 511 is formed in the circumferential direction of the shaft 510.

Alternatively, the protrusion support surface 511 may be a flat surface.

The rotation of the rotation restriction protrusion 545 in contact with the protrusion support surface 511 is restricted with respect to the shaft 510.

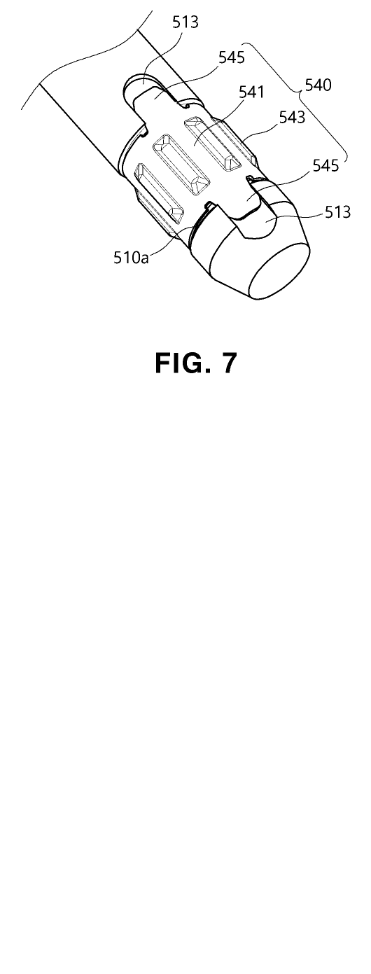

As another example, protrusion support portions may be protrusion insertion grooves 513 formed in an outer circumferential surface of a shaft 510 adjacent to a ring insertion groove 510a in a longitudinal direction as illustrated in FIG. 7. As a reference, FIG. 7 is a view illustrating one modified example of the protrusion support portions supporting rotation restriction protrusions according to one embodiment of the present invention.

The rotation of the rotation restriction protrusions 545 inserted into the protrusion insertion grooves 513 may be restricted with respect to a shaft 510 by being blocked by an inner sidewall defining the protrusion insertion groove 513.

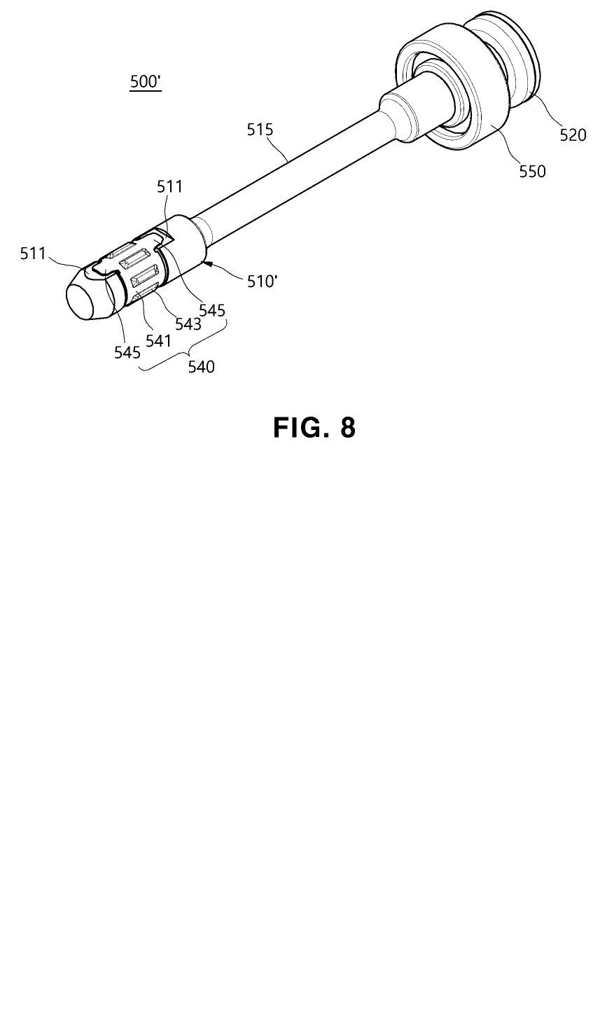

FIG. 8 is a perspective view illustrating a magnet assembly according to another embodiment of the present invention. Referring to FIG. 8, a magnet assembly 500’ may include a shaft 510’, a holder 520, a magnet 530, a tolerance ring 540, and a bearing 550.

In the magnet assembly 500’ according to another embodiment of the present invention, a shape of the shaft 510’ is different from that of the magnet assembly 500.

In another embodiment of the present invention, a high-elastic part 515 is provided on the shaft 510’. The high-elastic part 515 has greater elasticity than a remaining portion of the shaft 510’.

The high-elastic part 515 has high elasticity in a direction perpendicular to a longitudinal direction of the shaft 510’.

As an example, the high-elastic part 515 may be formed to have a relatively small cross-sectional area compared to the remaining portion of the shaft 510’.

Alternatively, although not illustrated in the drawings, the high-elastic part may be formed of a material having greater elasticity than the remaining portion. In this case, the high-elastic part may be formed to have a cross-sectional area which is the same as the remaining portion, and the high-elastic part and the remaining portion may be fixedly coupled to each other through a known method such as a welding method.

In another embodiment of the present invention, when an external force is applied to the shaft 510’ in a direction perpendicular to the longitudinal direction of the shaft 510’ while the shaft 510’ rotates along with a rotary shaft 210, the high-elastic part 515 of the shaft 510’ may be deformed to absorb the external force.

In this case, a state in which the shaft 510’ and the rotary shaft 210 are coaxially aligned on a line without being misaligned may be maintained, and thus, an amount of the rotation of a motor connected to the shaft 510’ can be stably and accurately measured.

In the hydraulic supply device 1 according to the present embodiment described above, since the magnet 530 is supported by the shaft 510 linearly coupled to the rotary shaft 210 as a simple structure, manufacturing thereof can be easy, and a gap between the magnet 530 and the MPS can be easily maintained, and thus, an operation state of the motor 100 can be effectively checked.

In addition, since the rotation restriction protrusion 545 formed on the tolerance ring 540 forming the magnet assembly 500 or 500’ restricts the rotation of the tolerance ring 540 around the shaft 510, the operation state of the motor 100 can be accurately measured.

In addition, since the high-elastic part 515 is provided on the shaft 510’ forming the magnet assembly 500’, even when an external force is applied to the shaft 510’ or the rotary shaft 210 in the direction perpendicular to the longitudinal direction of the shaft 510’, a state in which the shaft 510’ and the rotary shaft 210 are coaxially aligned on a line without being misaligned can be maintained, and the operation state of the motor 100 can be stably and accurately measured.

According to the above-described structure, in a hydraulic supply device according to one aspect of the present invention, since a magnet is fixed to a shaft linearly coupled to a rotary shaft as a simple structure, manufacturing thereof can be easy, a gap between the magnet and an MPS can be easily maintained, and thus an operation state of a motor can be easily checked.

In addition, since a rotation restriction protrusion formed on a tolerance ring forming a magnet assembly restricts the rotation of the tolerance ring around the shaft, the state of the motor can be accurately measured.

In addition, since a high-elastic part is provided on the shaft forming the magnet assembly, even when an external force is applied to the shaft or the rotary shaft in a direction perpendicular to a longitudinal direction of the shaft, a state in which the shaft and the rotary shaft are actually aligned on a line without being misaligned can be maintained, and the operation state of the motor can be stably and accurately measured.

It should be understood that the effects of the present disclosure are not limited to the above-described effects and include all effects inferable based on a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A hydraulic supply device comprising:
a motor which is coupled to a modulator block, in which a path and a valve for adjusting a hydraulic braking pressure are provided, and which includes a stator and a rotor;
a rotary shaft which is coupled to the rotor and performs a rotary motion along with the rotor; and
a magnet assembly which is coupled to the rotary shaft and includes a magnet disposed to face a motor position sensor for measuring an amount of rotation of the rotary shaft,
wherein the magnet assembly includes a shaft, which is coaxially and linearly connected to and rotated along with the rotary shaft and of which one end portion supports the magnet, and a tolerance ring which is mounted on an outer circumferential surface of the shaft and inserted into an installation groove formed in the rotary shaft to fasten the shaft to the rotary shaft,
wherein a rotation restriction protrusion for restricting rotation of the tolerance ring around the shaft is formed on the tolerance ring.

2. The hydraulic supply device of claim 1, wherein the tolerance ring includes:
a tolerance ring body which extends in a longitudinal direction of the shaft, is mounted on the outer circumferential surface of the shaft, and has a ring shape; and
at least one contact protrusion which is formed on an outer circumferential surface of the tolerance ring body and comes into contact with an inner circumferential surface of the installation groove.

3. The hydraulic supply device of claim 2, wherein the rotation restriction protrusion is supported by the shaft to restrict the rotation of the tolerance ring body around the shaft.

4. The hydraulic supply device of claim 3, wherein the rotation restriction protrusion is formed to extend in a longitudinal direction of the tolerance ring body from on at least one of one side and the other side of the tolerance ring body in the longitudinal direction.

5. The hydraulic supply device of claim 4, wherein a ring insertion groove, which extends in the longitudinal direction of the shaft and in which the tolerance ring body is inserted and mounted, is formed in the outer circumferential surface of the shaft.

6. The hydraulic supply device of claim 5, wherein a protrusion support surface, which is adjacent to the ring insertion groove in a longitudinal direction of the ring insertion groove and is in contact with and supports the rotation restriction protrusion, is formed on the outer circumferential surface of the shaft.

7. The hydraulic supply device of claim 6, wherein:
the protrusion support surface is formed as a curved surface; and
the protrusion support surface is formed to have a greater radius of curvature than a remaining region other than a region in which the protrusion support surface is formed in a circumferential direction of the shaft.

8. The hydraulic supply device of claim 6, wherein the protrusion support surface is formed as a flat surface.

9. The hydraulic supply device of claim 5, wherein a protrusion insertion groove, which is adjacent to the ring insertion groove in a longitudinal direction of the ring insertion groove and into which the rotation restriction protrusion is inserted, is formed in the outer circumferential surface of the shaft.

10. The hydraulic supply device of claim 2, wherein a cut portion extending in a longitudinal direction of the tolerance ring body is formed in the tolerance ring body.

11. The hydraulic supply device of claim 1, wherein:
the magnet assembly further includes a holder fixed to one end of the shaft and provided with an accommodation space; and
the magnet is mounted in the accommodation space.

12. The hydraulic supply device of claim 1, wherein the shaft is provided with a high-elastic part having greater elasticity than a remaining portion of the shaft.

13. The hydraulic supply device of claim 12, wherein the high-elastic part has a relatively small cross-sectional area compared to the remaining portion of the shaft.

14. The hydraulic supply device of claim 12, wherein the high-elastic part is located in a central region of the shaft.

15. The hydraulic supply device of claim 1, further comprising a ball nut of which one side is coupled to a piston and which is coaxially connected to the rotary shaft in a ball screw manner and converts a rotary motion of the rotary shaft to a linear motion.

16. The hydraulic supply device of claim 1, further comprising a bearing which rotatably supports the shaft,
wherein the bearing is supported by a pump housing coupled to the modulator block to surround a piston and the r shaft.

17. The hydraulic supply device of claim 1, further comprising a pump housing which is fastened to the modulator block from a side opposite to the motor and forms a cylinder such that a piston passing through the modulator block performs a reciprocating linear motion.

18. The hydraulic supply device of claim 17, wherein a guide part having a cylindrical shape of which one side is open is provided in the pump housing such that the cylinder is divided into a first space portion accommodating the shaft and a second space portion accommodating the piston.

19. A hydraulic supply device coupled to a modulator block in which a path and a valve for adjusting a hydraulic braking pressure is provided, the hydraulic supply device comprising:
a motor including a stator and a rotor;
a rotary shaft which is coupled to the rotor and performs a rotary motion along with the rotor; and
a magnet assembly coupled to the rotary shaft,
wherein the magnet assembly includes a shaft coaxially and linearly connected to and rotated along with the rotary shaft, a magnet which is supported by one end portion of the shaft and disposed to face a motor position sensor for measuring an amount of rotation of the rotary shaft, and a tolerance ring mounted on an outer circumferential surface of the shaft and inserted into an installation groove formed in the rotary shaft to fasten the shaft to the rotary shaft, and
the tolerance ring includes a tolerance ring body extending in a longitudinal direction of the shaft, mounted on the outer circumferential surface of the shaft, and having a ring shape and a rotation restriction protrusion formed on the tolerance ring body to restrict rotation of the tolerance ring body around the shaft.

20. The hydraulic supply device of claim 19, wherein the rotation restriction protrusion is formed to extend in a longitudinal direction of the tolerance ring body on at least one of one side and the other side of the tolerance ring body in the longitudinal direction.
